(19) United States
(12) Patent Application Publication
(10) Pub. No.: US 2017/0331425 A1
(43) Pub. Date: Nov. 16, 2017

(54) PORTABLE PHOTOVOLTAIC SYSTEM

(71) Applicant: Vincent Akira Allen, Corrimal, New South Wales (AU)

(72) Inventor: Vincent Akira Allen, Corrimal, New South Wales (AU)

(21) Appl. No.: 15/523,440

(22) PCT Filed: Nov. 3, 2015
(86) PCT No.: PCT/AU2015/000662

§ 371 Date: May 1, 2017

(30) Foreign Application Priority Data
Nov. 3, 2014 (AU) 2014904422

(51) Int. Cl. H02S 40/36; H02S 40/32; H02S 10/40

(52) U.S. Cl. CPC H02S 40/36; H02S 10/40; H02S 40/32

(57) ABSTRACT

The present disclosure provides a portable photovoltaic unit and a photovoltaic system. The system comprises a plurality of interconnectable photovoltaic module units each unit comprising a photovoltaic device. The units are arranged for releasably coupling to each other so that an electrical interconnection between the units is established and energy can be accessed from electrical contacts that are disposed on the same side of one of the units.

### FIELD OF THE INVENTION

The present invention generally relates to a portable photovoltaic system and a photovoltaic module unit, in particular the invention relates to a portable modular photovoltaic system comprising a plurality of interconnectable photovoltaic module units.

### BACKGROUND OF THE INVENTION

Portable photovoltaic systems provide a convenient solution to access electrical energy off-grid. A portable photovoltaic module, or array, can deliver DC power when its surface is exposed to sunlight.

Portable photovoltaic systems can be used, for example, during outdoor activities to charge electrical equipment, such as headlights or GPS receivers. Other uses include charging laptops or other portable devices at locations with no grid access, such as remote campsites.

Generally, portable photovoltaic systems include one or more photovoltaic modules. The size of the photovoltaic modules and the number of modules in the system are fixed. For example, a simple portable photovoltaic system may include two modules hinged together which can be folded onto each other to save space. Having a fixed size and number of modules means that the system can provide energy in a defined range, for a given intensity of sunlight.

Systems which generate a higher power output include several photovoltaic modules in an array configuration. The modules are generally interconnected in series to provide a higher voltage. These systems require conductive wires to access the voltage at the first and last module of the array. This can be cumbersome in some outdoor environments, in particular when dealing with a long array.

Furthermore, current portable photovoltaic systems are generally not as reliable as larger fixed photovoltaic systems. Portable systems are manufactured using lower grade materials and lower quality standards.

There is a need for a portable photovoltaic technology which can be used with different types of electrical equipment, it is easy to carry and is reliable.

### SUMMARY OF THE INVENTION

In accordance with a first aspect, the present invention provides a portable photovoltaic system comprising a plurality of interconnectable photovoltaic module units, each unit comprising a photovoltaic device and each unit being arranged for releasably coupling to at least one other unit in a manner such that an electrical interconnection between the units is established and energy that in use is generated by the entire array is accessible from electrical contacts that are disposed on the same side of one of the units. In an embodiment, one or more units comprise a return connection arranged to create a conductive path from one side of the unit to another side of the unit. The return connection may be integrated within the unit.

In an embodiment, the one of the units comprising the electrical contacts for accessing the energy generated by the entire array is disposed at one end of the array.

In an embodiment, each unit comprises:
a plurality of electrical contacts arranged to electrically interconnect the unit to an adjacent unit; and a plurality of releasably engageable retainers arranged to releasably attach the unit to an adjacent unit to form an array of photovoltaic modules.

In an alternative embodiment, each unit comprises a plurality of magnets arranged to electrically interconnect the unit to an adjacent unit and releasably attach the unit to an adjacent unit to form an array of photovoltaic modules. The magnets may be disposed on the peripheral region of each unit and may be coated with a conductive material.

In an embodiment, at least one of the units comprises a first and a second pair of magnets. The first pair of magnets may be disposed at one side of the at least one of the units and the second pair of magnetic contacts may be disposed at the opposite side.

One of the magnets of the first pair may be electrically connected to a portion with a first polarity of the respective photovoltaic device and one of the magnets of the second pair may be electrically connected to a portion with a second polarity of the photovoltaic device.

Further, one of the magnets of the first pair may be electrically connected to one of the magnets of the second pair to form a conductive path from the one side of the unit to the opposite side.

In an embodiment, the magnets of the first or the second pair are electrically connected to each other.

In an embodiment, at least one of the units comprises only one pair of magnets disposed on one side and the magnets are respectively electrically connected to a portion with a first polarity and a portion with a second polarity of the respective photovoltaic device. This unit may be disposed at one end of the array.

In an embodiment, the system further comprises an electronic device comprising a plurality of magnets arranged to electrically connect and to releasably attach the electronic device to the photovoltaic system. The electronic device may comprise a DC/DC converter, a maximum power point tracker, a DC/AC inverter or a voltage regulator.

In a further embodiment the system further comprises a battery having a plurality of magnets respectively arranged to electrically connect and to releasably attach the battery to the photovoltaic system.

In an embodiment, the system further comprises a plurality of flexible joining portions arranged to create flexible connections between the units. The flexible joining portions may comprise conductive flexible wires or conductive flexible sheets having a clamping mechanism arranged to be releasably attached to one or more of the plurality of magnets. The clamping mechanism may comprise one or more further magnets.

In accordance with a second aspect, the present invention provides a photovoltaic module unit for integration in a portable photovoltaic system, the photovoltaic module unit comprising a photovoltaic device and the unit being arranged for releasably coupling to at least one other unit in a manner such that an electrical interconnection between the units is established and when in use two or more units are electrically interconnected to form an array of units and energy that is generated by the entire array is accessible from electrical contacts that are disposed on the same side of one of the units. In an embodiment, the unit comprises a return connection arranged to create a conductive path from one side of the unit to another side of the unit. The return connection may be integrated within the unit and when two or more units are electrically interconnected in use to form an array of units, the return connection provides a current return path extending throughout the array.

In an embodiment, the unit comprises:
a plurality of electrical contacts arranged to electrically interconnect the unit to an adjacent unit; and
a plurality of releasably engageable retainers arranged to releasably attach the unit to an adjacent unit to form an array of photovoltaic modules.

In an alternative embodiment, the unit comprises a plurality of magnets arranged to electrically interconnect the unit to an adjacent unit and releasably attach the unit to an adjacent unit to form an array of photovoltaic modules. The plurality of magnets may be disposed on the peripheral region of the unit and may be coated with a conductive material.

In an embodiment, the plurality of electrical contacts comprises a first and a second pair of magnets. The first pair of magnets may be disposed at one side of the at least one of the units and the second pair of magnetic contacts may be disposed at the opposite side.

One of the magnets of the first pair may be electrically connected to a portion with a first polarity of the respective photovoltaic device and one of the magnets of the second pair may be electrically connected to a portion with a second polarity of the photovoltaic device. Further, one of the magnets of the first pair may be electrically connected to one of the magnets of the second pair to form a conductive path from the one side of the unit to the opposite side.

In an embodiment, the magnets of the first or the second pair are electrically connected to each other.

In an embodiment, the unit comprises an encapsulation layer and the return connection is disposed between the encapsulation layer and the photovoltaic device.

In a further embodiment, the unit comprises an insulation layer disposed between the return connection and the photovoltaic device to prevent electrical interaction between the return connection and the photovoltaic device. The encapsulation layer may comprise an EVA lamination, an epoxy resin, or a polymer based sheet.

In accordance with the third aspect, the present invention provides a method of forming a portable photovoltaic system comprising the steps of:
providing two or more photovoltaic module units in accordance with the second aspect; and
interconnecting the photovoltaic module units to form a photovoltaic array.

In accordance with a fourth aspect, the present invention provides a method of manufacturing a photovoltaic module unit for integration in a portable photovoltaic system, the method comprising the steps of:
providing a photovoltaic device;
forming a conductive path extending from one side of the unit to an opposite side;
encapsulating the photovoltaic device and the conductive path using an encapsulation layer; and
forming an interconnection assembly arranged to electrically connect the unit to an adjacent unit and to releasably attach the unit to an adjacent unit;
wherein when two or more units are electrically interconnected to form an array of units, the conductive path provides a current return path extending throughout the array.

In an embodiment, the step of providing a photovoltaic device comprises the steps of:
providing a plurality of solar cells; and
electrically connecting the solar cells to each other.

In an embodiment, the step of forming a conductive path comprises the steps of:
disposing an insulator extending from one side of the photovoltaic device to the opposite side of the photovoltaic device adjacent to a back portion of the photovoltaic device; and
disposing a conductor extending from one side of the unit to the opposite side adjacent to the insulator.

In an embodiment, the step of forming an interconnection assembly comprises the steps of:
forming a plurality of electrical contacts arranged to electrically interconnect the unit to an adjacent unit; and
mounting a plurality of releasably engageable retainers to the unit, the retainers being arranged to releasably attach the unit to an adjacent unit to form an array of photovoltaic modules.

In an alternative embodiment, the step of forming an interconnection assembly comprises the step of mounting a plurality of magnets to the unit, the magnets being arranged to electrically interconnect the unit to an adjacent unit and releasably attach the unit to an adjacent unit to form an array of photovoltaic modules.

The step of mounting a plurality of magnets may comprise the step of electrically connecting the magnets to the photovoltaic device. This may be done by attaching the magnets to the unit by soldering or gluing the magnets to the unit.

Advantageous embodiments provide a portable photovoltaic system which comprises a plurality of photovoltaic module units. Each unit includes one or more photovoltaic cells and can be releasably interconnected to one or more other units. The interconnection is realised using magnetic contacts which simultaneously provide a structural interconnection between the units and function as electrical contacts to form a photovoltaic array. The majority of the units include an integrated return connection. In some instances, for example when the units are connected in series, the unit at the end of the array may be different to the other units and have an internal connection to close the electrical circuit formed by the array of units. In some other instances, all the units are similar and a return unit is used to close the circuit. When the units are interconnected to form an array the integrated return connections are also connected to each other to form a return connection for the entire array. The integrated return connection provides convenient access to the energy produced by the array at one location using two contacts.

Advantageous aspects of the portable photovoltaic system include the feature of having separate system components which can be individually replaced without having to replace the entire system. The photovoltaic module units, the electronic devices such as the DC/DC converter or the voltage regulator and the battery, for example, may degrade or become out of date and needing to be replaced or upgraded.

In addition the portable photovoltaic system can be upsized or downsized depending on the type/size of load and the amount of power needed by the load.

### BRIEF DESCRIPTION OF THE DRAWINGS

Features and advantages of the present invention will become apparent from the following description of embodiments thereof, by way of example only, with reference to the accompanying drawings in which:

FIGS. 1 to 8 are schematic representations of a portable photovoltaic system in accordance with embodiments;

FIG. 9 is a flow diagram outlining the basic steps required to form a portable photovoltaic system in accordance with embodiments; and

FIG. 10 is a flow diagram outlining the basic steps required to form a photovoltaic module unit in accordance with embodiments.

### DETAILED DESCRIPTION OF EMBODIMENTS

Embodiments of the present invention relate to a portable photovoltaic system which includes a plurality of photovoltaic module units. The units are arranged to electrically connect to each other and to be releasably attachable to each other. In the embodiment described the units have an interconnection assembly provided in the form of a plurality of magnets arranged to electrically interconnect each unit to an adjacent unit and releasably attach the unit to an adjacent unit to form an array of photovoltaic modules. The magnets are disposed on the peripheral edge of the photovoltaic module units.

One or more of the units includes an integrated return connection which provides a return path for the electricity generated by the array so that the electricity can be accessed at a pair of contacts disposed on a single photovoltaic module unit.

In the embodiment described, the units can be connected in series or parallel and each unit has four conductive magnets. In some embodiments the final unit of the array may have only two conductive magnets.

The conductive magnets are used to releasably attach the units to each other, while, at the same time, create an electrical connection between the units. Four conductive magnets are used to contact the photovoltaic device inside the units and the integrated return connection within the unit. The final unit of the array may have only two conductive magnets. A pair of conductive magnets is disposed on each side of each unit. One conductive magnet for each pair is connected to the photovoltaic device. In the embodiment described, one of the conductive magnets on a first side of the unit is connected to the p-region of the photovoltaic device and one of the conductive magnets on a second side of the unit is connected to the n-region of the photovoltaic device.

For series connection of the units, the remaining two conductive magnets are connected to form the integrated return connection in a manner such that, when the units are connected to each other in an array, an electrical return connection can be created along the entire array to provide access to the electricity generated at one location, generally at the beginning of the array. The electrical return connection is created by electrically connecting the two magnets disposed at one side of the last unit of the array. Alternatively, when the final unit of the array has only two conductive magnets, the return connection is created without having to connect the two magnets at the last unit.

For parallel connection of the units, the remaining magnet on the first side is connected to the magnet which is connected to the n-region of the photovoltaic device. The remaining magnet on the second side is connected to the magnet which is connected to the p-type region of the photovoltaic device. These electrical connections form integrated return connections. With this configuration an electrical return connection can be created along the entire array to provide access to the electricity generated at one location, generally at the beginning of the array. Alternatively, the final unit of the array has only two conductive magnets on one side, with each magnet connected to a polarity of the photovoltaic device. This allows avoiding exposed electrical terminals when the array is in use.

When the conductive magnets of each unit of the system are in direct contact to form the array, the relative position of each unit in the array is fixed. An excessive bending of the array, for example, may disconnect one or more of the conductive magnets interrupting the current flow.

In some situations a degree of flexibility in the structure of the array is required. For example, a user may require fitting the photovoltaic array on a wearable item or a backpack to charge a mobile phone or a GPS device while hiking. In this situation one or more flexible joints are used to join the modules of the array so that the array can fit the shape of the backpack. In alternative situations a full flexible array may be required with a series of units attached to each other by flexible joining portions.

Flexible joining portions between the units are created by conductive wires or sheets which can be clamped using a clamping mechanism to the conductive magnets. The clamping mechanism may comprise a further magnet.

The interconnection assembly may be alternatively provided as a plurality of electrical contacts arranged to electrically interconnect the units to one another and a plurality of releasably engageable retainers which releasably attach the units to one another to form an array of photovoltaic modules.

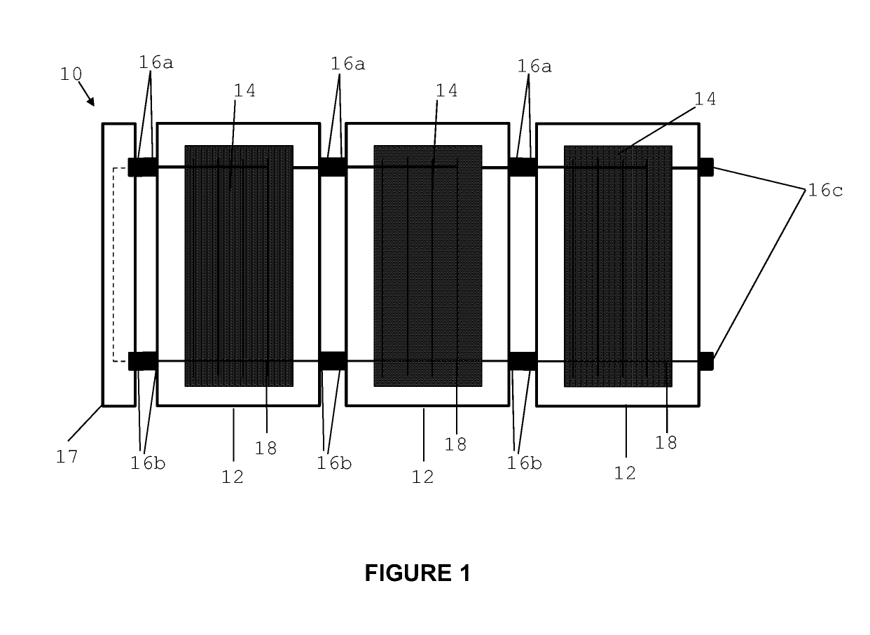

Referring now to FIG. 1, there is shown a schematic representation of a portable photovoltaic system 10 in accordance with an embodiment. System 10 comprises three interconnected photovoltaic module units 12 connected in series. Each unit comprises a single photovoltaic cell 14.

In alternative embodiments, cell 14 may be formed by two or more photovoltaic cells interconnected (either in series or parallel) within the unit.

Each unit 12 comprises a plurality of electrical contacts disposed on the sides. In this embodiment the electrical contacts are provided in the form of magnets 16. Magnets 16 comprise Neodymium and are coated with a nickel layer or a combination of nickel, copper and tin. Magnets 16 provide electrical connection between the units. At the same time, their magnetic force allows to releasably attach the units to one another to form an array of photovoltaic modules. The units 12 can be separated by pulling apart with a sufficient force to overcome the magnetic force attracting the magnets. In alternative embodiments, the magnets may be substituted with other forms of releasably engageable retainers disposed on the peripheral region of each unit, such as pressure clips, dome clips or hoop and loop material.

Each unit 12 comprises two pair of magnets. A first pair of magnets (16a and 16b) is disposed on the left side of the unit 12. Another pair of magnets (16a and 16b) is disposed on the right side of the unit.

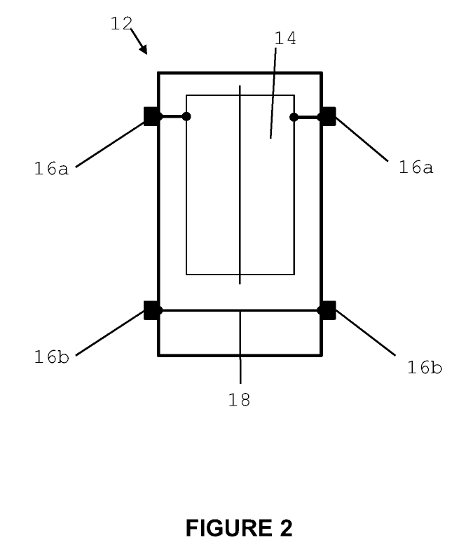

FIG. 2 shows a schematic view of a single unit 12. The photovoltaic device in unit 12 of FIG. 2 is depicted schematically to show the P polarity and the N polarity. One of magnets 16a is electrically connected to the portion of the photovoltaic device with the P polarity and the other one of magnets 16a is electrically connected to the portion of the photovoltaic device with the N polarity. In particular, the left magnet 16a is connected to the N-type portion of the photovoltaic device and the right magnet 16a is connected to the P-type portion of the photovoltaic device. This configuration of magnets 16a and 16b allows connecting the units in series, as shown for units 12 in FIG. 1.

Each unit 12 also comprises an integrated return connection 18. The integrated return connection 18 allows accessing the energy generated by the entire array from a pair of electrical contacts 16c (FIG. 1) disposed at the same side of one of the units. FIG. 2 shows the integrated return connection 18 of a single unit 12. Magnets 16b are electrically connected to return connection 18 to form a conductive path from the one side of the unit 12 to the opposite side.

When more units 12 are interconnected together in series to form an array of photovoltaic modules, as shown in FIG. 1, each return connection 18 forms a portion of the integrated array return connection. Such integrated array return connection allows using the energy generated by the entire array by connecting to the two magnets 16c disposed at one end of the array. Each module integrated return connection 18 is integral to the module, is disposed within the module encapsulation and connected to the two magnets 16b. Units 12 do not show any other external wire or return connection other than the return connection 18. In the schematic representation of FIG. 2, the return connection 18 is electrically separated from the photovoltaic device 14. The array return connection is formed at the time of interconnection of units 12 and no additional wiring or connections are required.

In the units of FIG. 1, the photovoltaic device 14 occupies the majority of the unit area to take advantage of the entire surface area of the unit. The units 12 are encapsulated using an encapsulation layer and the return connection 18 is disposed between the encapsulation layer and the photovoltaic device 14. To avoid any electrical interference between the return connection 18 and the photovoltaic device 14 a polymeric insulation layer is disposed between the return connection 18 and the photovoltaic device 14.

The array 10 of FIG. 1 has a return unit 17 which provides a connection between the N-type region of the last solar cell of the array (left side) and the integrated return connection of the array. The return unit 17 has two magnets which engage and electrically connected to magnets 16a and 16b on the left side of the last unit of the array. The return unit 17 creates an electrical connection between these two magnets so that the N-type region of the last solar cell can be electrically contacted from the first module of the array (right side) through the bottom magnet 16c and the integrated return connection.

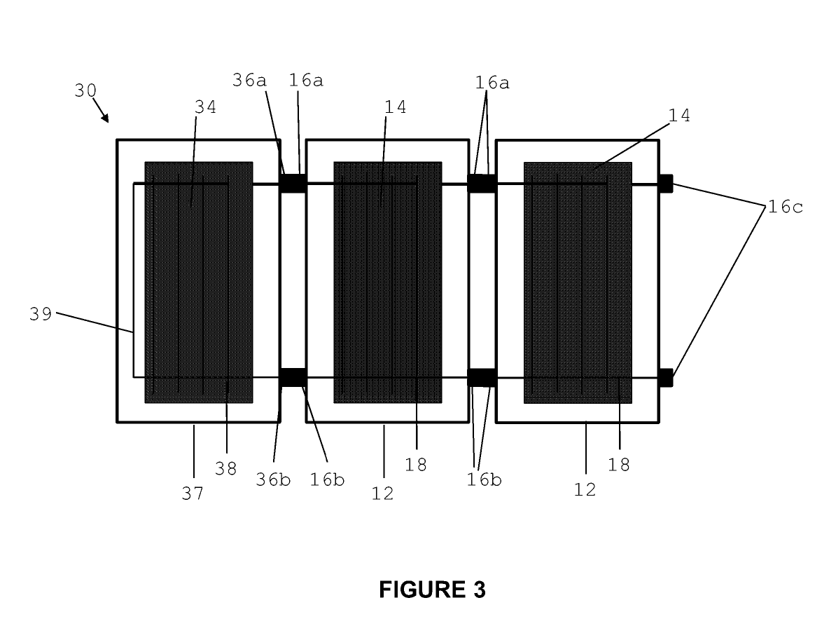

Referring now to FIG. 3 there is shown an alternative embodiment of a portable photovoltaic system. In the system 30 of FIG. 3, the return unit 37 is an actual photovoltaic module unit. Unit 37 has only two magnetic contacts on the right side 36a and 36b which allow connecting the photovoltaic device 34 in series. Unit 37 also has an integrated return connection 39 between the N-type region of the photovoltaic device 34, the integrated return path 38 and magnet 36b.

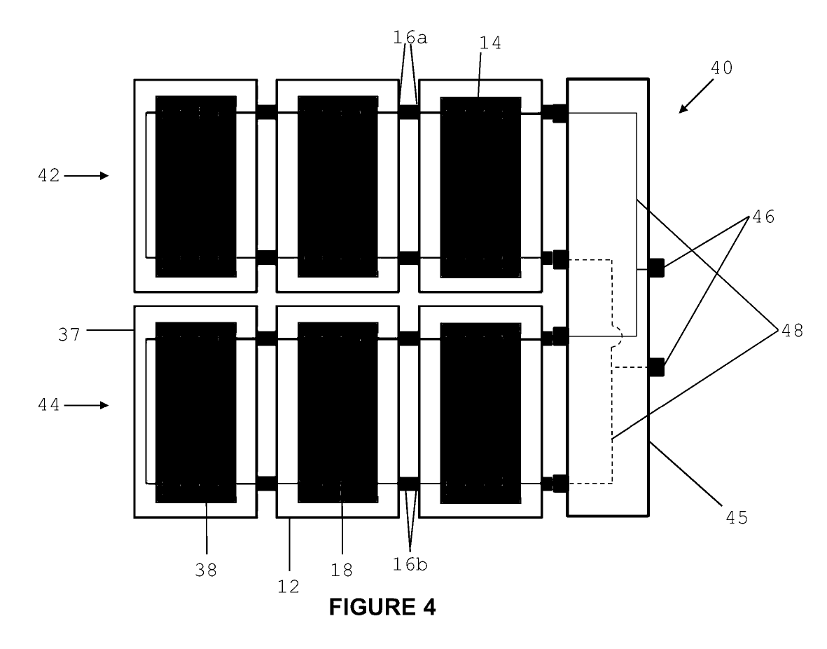

Referring now to FIG. 4, there are shown two arrays 42 and 44 of the type illustrated in FIG. 3 interconnected in parallel by interconnecting magnetic contacts 16c. The interconnection unit 45 interfaces the two arrays 42 and 44 with a four magnet interface. The two integrated arrays are attached to the interconnection unit 45 which comprises parallel interconnections 48. The energy generated by the two arrays 42 and 44 in parallel can be accessed from contacts 46 of the interconnection unit 45. Contacts 46 are configured in the same way as contacts 16a and 16b so that any electronic device suitable for connection to a single array can also be connected to the arrays in parallel configuration. The parallel configuration of FIG. 4 allows providing a higher current at the terminals 46 while maintaining a voltage which is proportional to the number of units included in the arrays 42 and 44. An increased current may, for example, decrease the amount of time required to charge a battery using the array.

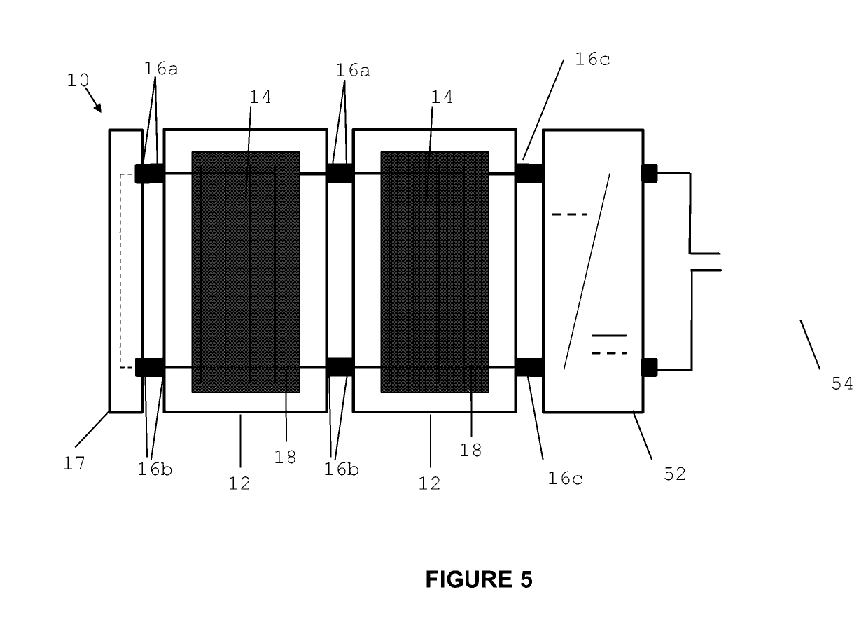

A variety of electronic devices can be designed to be attached and integrated with the portable photovoltaic system. FIG. 5 shows an example of the application of the array 10 of FIG. 1 to charge a laptop computer. A DC/DC converter 52 is connected to the photovoltaic array to bring the output DC voltage of the array in a DC range usable by the laptop computer 54. The array output DC voltage depends on the number of units 12 interconnected in series. The DC/DC converter 52 allows changing and regulating this voltage. DC/DC converter 52 may be designed to have four magnetic contacts as the photovoltaic module units 12. The converter 52 can be connected to the array in the same way as an additional unit 12 is connected to the array. In the embodiment of FIG. 5, the output of the converter 52 is connected to the laptop computer 54 using wiring. However in alternative embodiments the magnetic contacts at the output of the converter can be connected to the laptop 54 directly. In alternative embodiments, the converter 52 may be designed to have only one pair of magnets, to interface the photovoltaic system, and an output port to connect to laptop computer 54 or any other electric device. A voltage regulator can also be connected to the photovoltaic system in the same fashion as DC/DC converter 52 to regulate the voltage output of the array.

In some embodiments the portable photovoltaic system also comprises a battery. The battery has an input interface connected to the photovoltaic system. Alternatively the battery may be connected to the converter 52 via a cable. It is useful to have a battery fully integrated with the portable photovoltaic system as it allows exploiting the solar energy at any time by accumulating the energy in the battery. For example, a portable photovoltaic system with a battery configured on a hiking backpack can be used to accumulate energy during hiking. The energy may then be used to power a portable light which can be attached to the battery output interface.

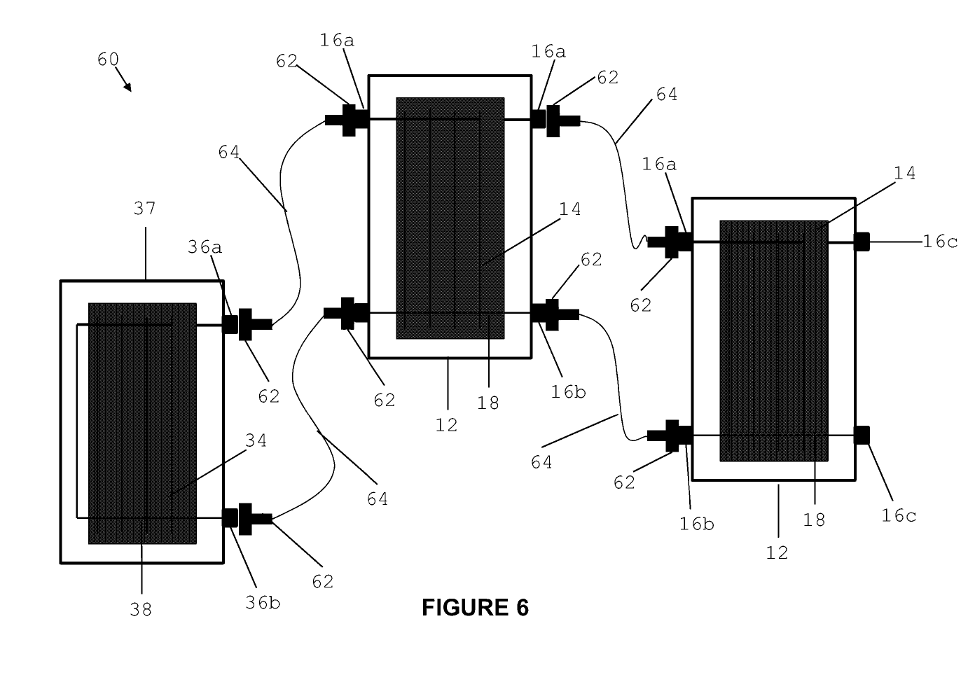

Referring now to FIG. 6, there is shown an alternative embodiment 60 of the portable photovoltaic array 30 of FIG. 3. In the system 60 the magnetic contacts of the units 12 and 37 are not directly interconnected to each other creating a rigid array of photovoltaic modules. Instead a plurality of flexible joining portions arranged to create flexible connections between the units are used.

The flexible joining portions comprise conductive flexible wires 64 which have a clamping mechanism arranged to be releasably attached to one or more of the plurality of magnets. In system 60 the clamping mechanisms are provided as magnetic contacts 62. Magnetic contacts 62 are attached to the flexible wires 64 and can be magnetically connected to magnets 16 or 36. In alternative embodiments, the conductive wires 64 may terminate with a clamping mechanism arranged to engage magnets 16 or 36. The clamping mechanisms may be provided, for example, in the form of a conductive clip.

Flexible joining portions allow creating a flexible array which can conform to irregular surfaces. Going back to the hiking example, two or more flexible joining portions allow configuring the array to be setup on a hiking backpack and thereby follow the backpack profile. The array can be configured to be partially flexible by introducing, for example, two flexible joining portions at one location. Alternatively, the array can be configured to be fully flexible, by interconnecting each unit using flexible joining portions.

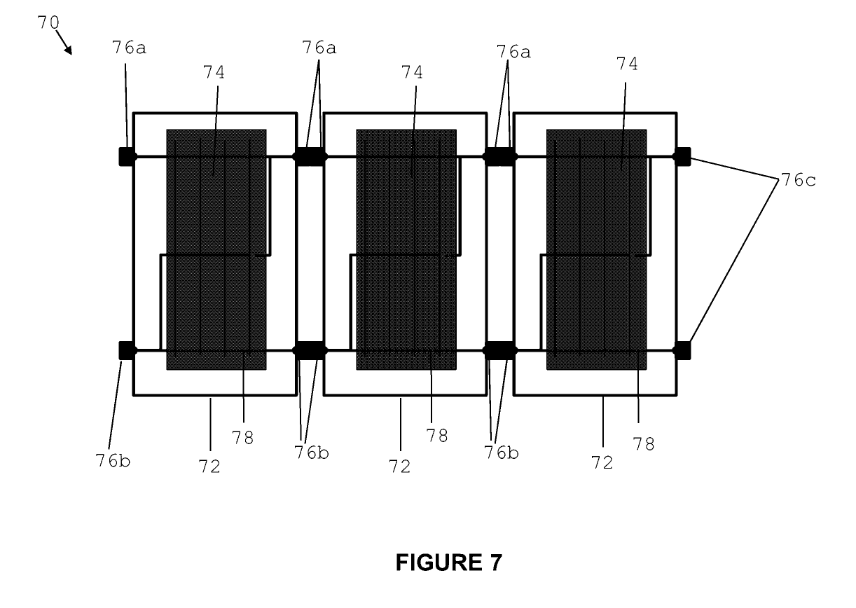

Referring now to FIG. 7, there is shown a schematic representation of a portable photovoltaic system 70 in accordance with an embodiment. System 70 comprises three interconnected photovoltaic module units 72 connected in parallel. Each unit comprises a single photovoltaic cell 74. In alternative embodiments, cell 74 may be formed by two or more photovoltaic cells interconnected (either in series or parallel) within the unit.

Each unit 72 comprises two pair of magnets. A first pair of magnets (76a and 76b) is disposed on the left side of the unit 72. Another pair of magnets (76a and 76b) is disposed on the right side of the unit.

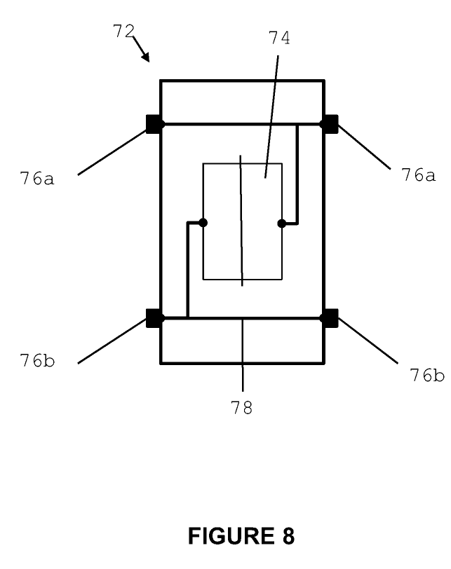

FIG. 8 shows a schematic view of a single unit 72. The photovoltaic device in unit 72 of FIG. 8 is depicted schematically to show the P polarity and the N polarity. Magnet 76a on the right side of the unit is electrically connected to the portion of the photovoltaic device with the P polarity and magnet 76b on the left side is electrically connected to the portion of the photovoltaic device with the N polarity. The magnet 76a on the left side is connected to the magnet 76a on the right side and the magnet 76b on the right side is connected to the magnet 76b on the left side forming a return connection 78. This configuration of magnets 76a and 76b allows connecting the units in parallel, as shown for units 72 in FIG. 7.

The integrated return connection 78 allows accessing the energy generated by the entire array from a pair of electrical contacts 76c (FIG. 7) disposed at the same side of one of the units. FIG. 8 shows integrated return connection 78 of a single unit 72. Magnets 76b are respectively connected to return connection 78 to form a conductive path from the one side of the unit 72 to the opposite side. Current generated by the photovoltaic devices travels through the connections between magnets 76a, which are connected to the P polarity, through the load and returns through the return connections 78.

When more units 72 are interconnected together in parallel to form an array of photovoltaic modules, as shown in FIG. 7, each return connection 78 forms a portion of the integrated array return connection. Such integrated array return connection allows using the energy generated by the entire array by connecting a load to the two magnets 76c disposed at one end of the array. Each module integrated return connection 78 is integral to the module, is disposed within the module encapsulation and connected to the two magnets 76b. Units 72 do not show any other external wire or return connection other than the return connection 78. The array return connection is formed at the time of interconnection of units 72 and no additional wiring or connections are required.

In the units of FIG. 7, the photovoltaic device 74 occupies the majority of the unit area to take advantage of the entire surface area of the unit. The units 72 are encapsulated using an encapsulation layer and the return connection 78 is disposed between the encapsulation layer and the photovoltaic device 74. To avoid any electrical interference between the return connection 78 and the photovoltaic device 74 a polymeric insulation layer is disposed between the return connection 78 and the photovoltaic device 74.

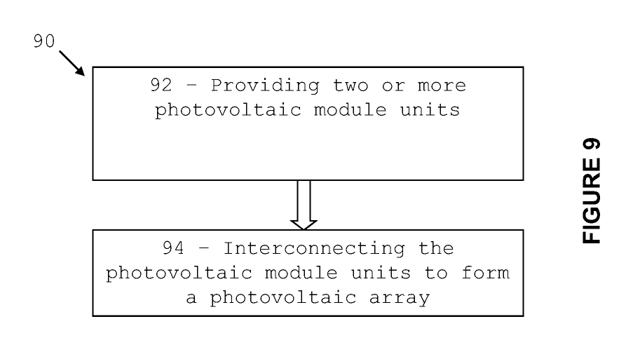

Referring now to FIG. 9, there is shown a flow diagram 90 outlining the basic steps required to form a portable photovoltaic system. Two or more photovoltaic module units are provided, step 92, and the photovoltaic module units are then connected together engaging the magnets to form a portable array, step 94. An energy utiliser unit, such as a laptop computer, a PDA or a smartphone can then be connected to the array. In some embodiments an interface device, such as a DC/DC converter or a voltage regulator is connected between the array and the PDA device. In other embodiments, a battery can be connected to the portable photovoltaic system to store the energy generated by the array.

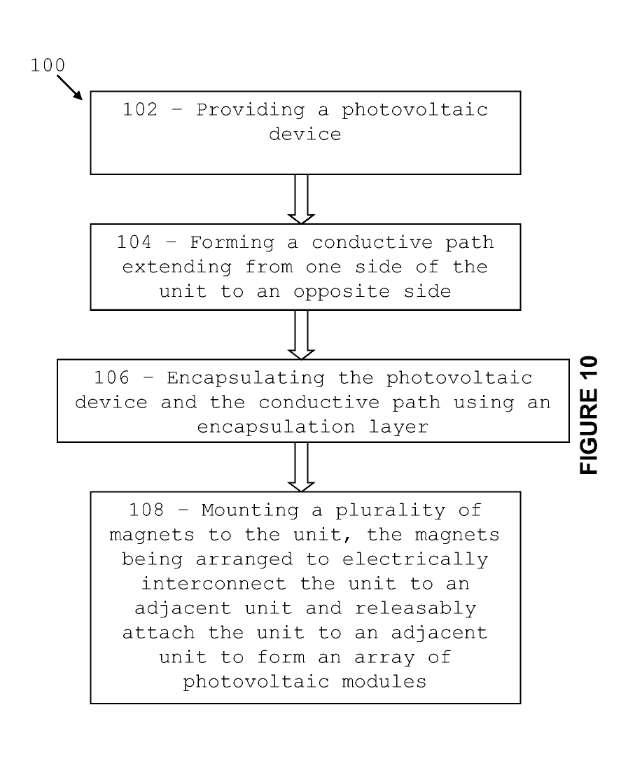

Referring now to FIG. 10 there is shown a flow diagram 100 outlining the basic steps required to form a photovoltaic module unit. A photovoltaic device is provided at step 102, the photovoltaic device can be provided as a single solar cell or a plurality of interconnected solar cells. A conductive path extending from one side of the unit to an opposite side is then formed in the unit, step 104. The conductive path is disposed between the back of the photovoltaic device and the unit encapsulation layer. In order to form the conductive path, an insulator extending from one side of the photovoltaic device to the opposite side of the photovoltaic device is disposed adjacent to a back portion of the photovoltaic device and a conductor extending from the one side of the unit to the opposite side is then disposed adjacent the insulator.

The photovoltaic device and the conductive path are encapsulated using an encapsulation layer, at step 106. A transparent front cover may be placed at the front of the unit and a back sheet is placed at the back of the unit. The back sheet may comprise a transparent glass sheet or a polymeric sheet. The encapsulation layer may be an EVA lamination layer or may comprise an epoxy resin or a polymer based sheet. The front cover may be a transparent polymeric sheet or a tempered glass sheet. A plurality of magnets are mounted to the unit at step 108. The magnets are arranged to electrically interconnect the unit to an adjacent unit and releasably attach the unit to an adjacent unit to form the array of photovoltaic modules. This step involves electrically connecting a plurality of peripheral magnets to the photovoltaic device. At least one of the magnets is in electrical contact with the N-type region of the photovoltaic device and at least another one of the magnets is in electrical contact with the P-type region of the photovoltaic device.

The photovoltaic module unit may be formed by performing the steps of method 100 in a different order to the sequence described and illustrated in FIG. 10.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1-44. (canceled)

45. A portable photovoltaic system comprising a plurality of interconnectable photovoltaic module units, each unit comprising a photovoltaic device and each unit being arranged for releasably coupling to at least one other unit in a manner such that an electrical interconnection between the units is established and energy that in use is generated by the entire array is accessible from electrical contacts that are disposed on the same side of one of the units.

46. The photovoltaic system of claim 45 wherein each unit comprises a return connection arranged to create a conductive path from one side of the unit to another side of the unit.

47. The photovoltaic system of claim 45 wherein the one of the units comprising the electrical contacts for accessing the energy generated by the entire array is disposed at one end of the array.

48. The photovoltaic system of claim 46 wherein the return connection is integrated within the unit.

49. The photovoltaic system of claim 45 wherein each unit comprises:
a plurality of electrical contacts arranged to electrically interconnect the unit to an adjacent unit; and
a plurality of releasably engageable retainers arranged to releasably attach the unit to an adjacent unit to form an array of photovoltaic modules.

50. The photovoltaic system of claim 45 wherein each unit comprises a plurality of magnets arranged to electrically interconnect the unit to an adjacent unit and releasably attach the unit to an adjacent unit to form an array of photovoltaic modules.

51. The photovoltaic system of claim 50 wherein the plurality of magnets are disposed on the peripheral region of each unit and are coated with a conductive material.

52. The photovoltaic system of claim 50 wherein at least one of the units comprises a first and a second pair of magnets.

53. The photovoltaic system of claim 52 wherein the first pair of magnets is disposed at one side of the at least one of the units and the second pair of magnetic contacts is disposed at the opposite side.

54. The photovoltaic system of claim 53 wherein one of the magnets of the first pair is electrically connected to a portion with a first polarity of the respective photovoltaic device and one of the magnets of the second pair is electrically connected to a portion with a second polarity of the photovoltaic device.

55. The photovoltaic system of claim 53 wherein one of the magnets of the first pair is electrically connected to one of the magnets of the second pair to form a conductive path from the one side of the unit to the opposite side.

56. The photovoltaic system of claim 52 wherein the magnets of the first or the second pair are electrically connected to each other.

57. The photovoltaic system of claim 50 wherein at least one of the units comprises only one pair of magnets disposed on one side and wherein the magnets are respectively electrically connected to a portion with a first polarity and a portion with a second polarity of the respective photovoltaic device.

58. The photovoltaic system of claim 57 wherein the at least one of the plurality of units is disposed at one end of the array.

59. The photovoltaic system of claim 50 further comprising a device comprising a plurality of magnets arranged to electrically connect and to releasably attach the electronic device to at least one of the units.

60. The photovoltaic system of claim 59 wherein the electronic device comprises a DC/DC converter, a maximum power point tracker, a DC/AC inverter or a voltage regulator or a battery.

61. The photovoltaic system of claim 45 further comprising a plurality of flexible joining portions arranged to create flexible connections between the units.

62. The photovoltaic system of claim 50 further comprising a plurality of flexible joining portions arranged to create flexible connections between the units, wherein the flexible joining portions comprise conductive flexible wires having a clamping mechanism arranged to be releasably attached to one or more of the plurality of magnets.

63. A photovoltaic module unit for integration in a portable photovoltaic system, the photovoltaic module unit comprising a photovoltaic device and the unit being arranged for releasably coupling to at least one other unit in a manner such that an electrical interconnection between the units is established and when in use two or more units are electrically interconnected to form an array of units and energy that is generated by the entire array is accessible from electrical contacts that are disposed on the same side of one of the units.

64. The photovoltaic module unit of claim 63 wherein the unit comprises an encapsulation layer and the return connection is disposed between the encapsulation layer and the photovoltaic device and wherein the unit further comprises an insulation layer disposed between the return connection and the photovoltaic device to prevent electrical interaction between the return connection and the photovoltaic device.
